(19) United States
(12) Patent Application Publication
(10) Pub. No.: US 2020/0207045 A1
(43) Pub. Date: Jul. 2, 2020

(54) METHOD AND APPARATUS FOR MANUFACTURING TIRES

(71) Applicant: HARBURG-FREUDENBERGER MASCHINENBAU GMBH, Hamburg (DE)

(72) Inventors: Markus WACHTER, Ahrensburg (DE); Achim BEHRENS, Asendorf (DE); Thomas LANGE-KRAUEL, Hamburg (DE)

(21) Appl. No.: 16/621,181

(22) PCT Filed: Apr. 20, 2018
(86) PCT No.: PCT/DE2018/000112

§ 371 Date: Dec. 10, 2019

(30) Foreign Application Priority Data
Jun. 16, 2017 (DE) 10 2017 005 818.0

(51) Int. Cl. B29D 30/32

(52) U.S. Cl. CPC B29D 30/32; B29D 2030/3264

(57) ABSTRACT

A method and an apparatus for manufacturing uncured green tires. The apparatus includes a tire building drum with a device for creating a ply turn-up, the device including a plurality of turn-up fingers. The turn-up fingers are coupled, via sliding rings, to a drive unit located outside the tire building drum. The drive unit and the turn-up fingers are coupled to each other in such a way that they can be coupled both when the tire building drum is at a standstill and when same rotates.

The invention relates to an apparatus for manufacturing tires. The invention moreover relates to a method for manufacturing tires. The apparatus comprises a tire building drum, having a device for realizing a ply turn-up, for manufacturing uncured green tires.

When manufacturing uncured green tires, air bellows are typically used to provide the contact pressure forces required for the ply turn-up. Drums of this type are relatively expensive and require the air bellows to be changed at specified cyclic intervals. It is already known practice from EP-A 1 001 876 to realize mechanical bead turn-up apparatuses in which the required contact pressure is achieved using a plurality of individual levers, which are arranged to resemble the struts of an umbrella. These mechanical apparatuses have a longer useful life than when air bellows are used, but do not enable symmetrical movements.

A tire building drum and a method for manufacturing tires which enable symmetrical movements are known from DE 2006 012 026 A1.

It is disclosed in DE 2006 012 026 A1 that the device for realizing the ply turn-up has a plurality of turn-up fingers, which are coupled via slide rings to a drive which is arranged outside the tire building drum.

In this case, a displacement of the turn-up fingers is realized with the aid of the core-setting apparatus, which turn-up fingers can be coupled into a coupling means of the tire building drum as a result of a radial displacement and, after the coupling, couple the drive to the turn-up fingers as a result of an axial displacement.

However, the apparatus described in said prior art only enables coupling of the turn-up fingers to the drive without simultaneous rotation of the tire building drum. This limits the field of application of a tire building drum designed in this way to the manufacture of tire structures in which the belt package is turned up over the sidewalls of the green tire (TOS—tread over sidewall).

For the manufacture of tire structures in which the sidewalls of the green tire are turned up over the belt package (SOT—sidewall over tread), it is, on the other hand, necessary for a rotation of the tire building drum to be enabled during the manufacturing procedure. So that the casing remains fixed on the drum with pinpoint accuracy, an outer shoulder realized at least during the rotation is required to prevent the casing being released from its clamp due to occurring pressure forces.

Possible pressure forces which could cause slipping of the casing on the drum occur for example in the form of the internal casing pressure in conjunction with the pressure forces from rolling the casing during the manufacture of the green tire.

An object of the invention, therefore, is to construct an apparatus for manufacturing tires with a drive for the turn-up fingers which is mounted outside the tire building drum in such a way that the manufacture of tire structures both with an SOT construction and with a TOS construction is enabled.

This object is achieved according to the invention by realizing an apparatus for manufacturing tires according to the features disclosed in the independent claim 1.

According to claim 1, an apparatus according to the invention for manufacturing tires has a tire building drum for manufacturing uncured green tires, wherein the tire building drum has a device for realizing a ply turn-up. The device for realizing the ply turn-up comprises a plurality of turn-up fingers, which can be coupled via at least two slide rings to a drive arranged outside the tire building drum. According to the invention, the turn-up fingers can be coupled to the drive and controlled thereby both in a stationary state and during a rotation of the tire building drum.

A further object of the invention is to define a method for manufacturing tires using a tire building drum with a drive for the turn-up fingers which is mounted outside the tire building drum, by means of which the manufacture of tire structures both with an SOT and with a TOS construction is enabled.

This object is achieved according to the invention by a method for manufacturing tires according to the features disclosed in independent claim 13.

In an advantageous embodiment of the apparatus according to the invention for manufacturing tires, the drive for the turn-up fingers is mounted in a stationary tire building ring and preferably has three spindles, which can be advantageously driven separately, in opposite directions and synchronously. A torque control is preferably used as a control system. To adjust the spindles, servomotors are preferably used, which are particularly preferably formed as alternating-current or three-phase drives.

The three spindles are furthermore preferably arranged at substantially the same distances from one another in a circumferential direction.

In an advantageous embodiment, the force transmission from the drive spindles to the corresponding mechanism integrated in the tire building drum takes place via radially displaceable drivers. In a particularly advantageous embodiment of the invention, the drivers can be part of the core-setting apparatus.

By arranging the drive outside the tire building drum, it is possible to actuate the turn-up fingers via so-called slide rings, which establish completely symmetrical movements of the individual turn-up fingers. This enables green tires with a very high and even quality to be produced.

To exert an even force on a green tire, the turn-up fingers, in an advantageous embodiment of the invention, are arranged evenly, particularly advantageously equidistantly, over the circumference of the tire building drum. Depending on the diameter of the tire building drum, the apparatus according to the invention for manufacturing tires advantageously has approximately 40 to approximately 80 turn-up fingers per drum half.

In a preferred embodiment of an apparatus according to the invention for manufacturing tires, the tire building drum has a drum shaft, an inboard and an outboard drum half and a center part.

In a particularly preferred embodiment of the invention, the inner and outer drum halves are mounted on the drum shaft to be movable in the axial direction. In an advantageous embodiment of the invention, the center part is firmly connected to the drum shaft.

The inner and the outer drum halves each have a core-clamping apparatus and a shoulder support, which can be displaced in the radial direction relative to the axis of the drum shaft.

In an advantageous embodiment, the inner and the outer drum halves furthermore each have a plurality of turn-up fingers by means of which the plies of the material for tire manufacture can be turned up. In a particularly advantageous embodiment of the invention, the turn-up fingers are guided via a forced-guidance means in the region of the drum halves in such a way that a particularly advantageous exertion of force on a green tire to be manufactured is realized.

The radially displaceable drivers of the drive mounted outside the tire building drum can be coupled to the turn-up fingers via the slide rings arranged in the region of the drum halves. In an advantageous embodiment, the slide rings have a ring groove which serves as a counter-structure of the coupling apparatus for receiving the drivers.

In a particularly advantageous embodiment of an apparatus according to the invention for tire manufacture, the drive arranged outside the tire building drum can be coupled to the slide rings in such a way that a coupling of the drive and the turn-up fingers can be realized both in a stationary state and during a rotation of the tire building drum.

According to the invention, the rotation-tolerant coupling of the drive and the turn-up fingers advantageously takes place via a rotatable bearing of the slide rings, which is formed in each case as an anti-friction bearing, for example. In an advantageous variant of the invention, the anti-friction bearings can be formed as ball bearings and, in a further advantageous embodiment of the invention, as roller bearings.

However, other embodiments of a rotation-tolerant coupling of the drive and the turn-up fingers are also envisaged. In this regard, an arrangement of the element enabling the rotation in the coupled state is envisaged in the region of the drive-side coupling elements, which can have, for example, elements which are rotatable about a radial axis relative to the drum shaft of the tire building drum, at least in the region of the coupling.

Furthermore, an electromagnetic coupling of the drive and the slide ring is envisaged, which realizes a rotation-tolerant coupling of the drive and the slide ring via magnetic fields.

An inventive rotatable bearing of the slide rings enables the position of the turn-up fingers to be controlled with the aid of the drive arranged outside the tire building drum in the case of both a stationary and a rotating tire building drum, so that the turn-up fingers in the region of a green tire to be manufactured can be controlled for a targeted exertion of force, such as for at least temporarily realizing at least one outer shoulder. The cores of the green tire can thus also be additionally fixed on the outside during a rotation of the tire building drum.

In a further advantageous embodiment of an apparatus for manufacturing tires, green tires both with a flat construction and with a crown construction can be produced.

This is advantageously realized in that the casing machine has a second drive unit. The apparatus according to the invention additionally has a replaceable tire building drum, which supports at least one construction type in each case.

In an advantageous embodiment of the method according to the invention for manufacturing tires, green tires both with a flat construction and with a crown construction can be produced. This is realized according to the invention by controlling a second drive unit in the casing machine for manufacturing tires with a crown construction.

A method according to the invention for manufacturing tires is furthermore characterized in that, by using an apparatus for tire manufacture with a drive for the turn-up fingers which is mounted outside the tire building drum and with a rotation-tolerant coupling of the drive and the turn-up fingers, tires both with an SOT and with a TOS construction can be produced.

A typical sequence of a method according to the invention for manufacturing tires is described below. The building materials for manufacturing a casing are applied in plies on the cylindrical drum body with retracted turn-up fingers, a core-clamping apparatus and a shoulder support. Two cores are then set on the drum body by means of a segmented, ring-shaped core-setting apparatus. The cores are then fixed on the tire building drum with the aid of the core-clamping apparatus.

The core-setting apparatus is in turn mounted in the tire building ring on left-/right-hand spindles, which can be displaced axially via servomotors in a precise and program-controlled manner.

After setting the cores, the left and right core-setting apparatus (drivers) move outwards so that they are positioned over the coupling means (ring grooves of the slide rings). The combined core-setting and axial drive segments are now displaced radially inwards into the coupling means. The servo-controlled connection between the core-setting apparatus and the turn-up fingers is thus produced.

The distance between the cores is reduced by the rotation of a spindle within the drum shaft. At the same time, the shoulder support is extended radially and forms a stable arrangement for the following ply turn-up process. A plurality of turn-up fingers, which are arranged close together on the inboard and outboard drum halves, lift the casing material lying on them.

Depending on the tire construction type (SOT or TOS) to be manufactured, the running strip belt package in the case of a rotating tire building drum or the sidewall material is firstly rolled along the forming casing.

With an increasing reduction in the core distances and a simultaneous supply of compressed air into the bulging casing, the turn-up fingers are deflected outwards via the axial movement. The rollers of the turn-up fingers of the inboard and the outboard drum halves roll the casing material completely symmetrically along the forming casing (green tire). The outwardly deflected turn-up fingers form increasing distances in the roller head region, which are in turn filled by a double roller mechanism.

Flat rolling during the ply turn-up is thus achieved, and air pockets are therefore prevented. After completing the ply turn-up, further green body components are supplied on the outside.

The tire building drum is provided with an external servo-controlled core-setting apparatus which is coupled as required. Completely synchronous running of the roller systems of both drum halves is thus ensured. At the same time, the motor-driven synchronous running does not result in any “slip-stick effects” or awkward/unstable adjustments in a pneumatic turn-up finger operation. As a result, the user can expect a considerably improved true running quality/evenness, particularly in terms of better conicity and lateral force fluctuations.

In a modular construction, the tire building drum according to the invention shall have further advantages. The region of the core clamping and shoulder support can be realized identically to form a two-bellows drum type, resulting in completely reliable core clamping in conjunction with a radially extendable mechanical shoulder support.

Despite the use of turn-up fingers with all their spacings, the tire building drum has a completely continuous axial bearing surface for forming an automatic splice joint.

Exemplary embodiments of the invention are illustrated schematically in the drawings, which show:

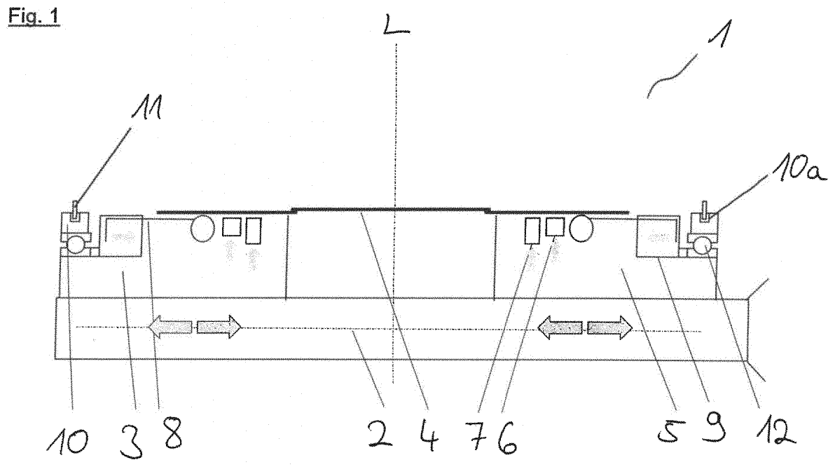

FIG. 1 a partial view of a longitudinal section through a tire building drum according to the invention, with a mechanical device for realizing a ply turn-up without material applied thereto;

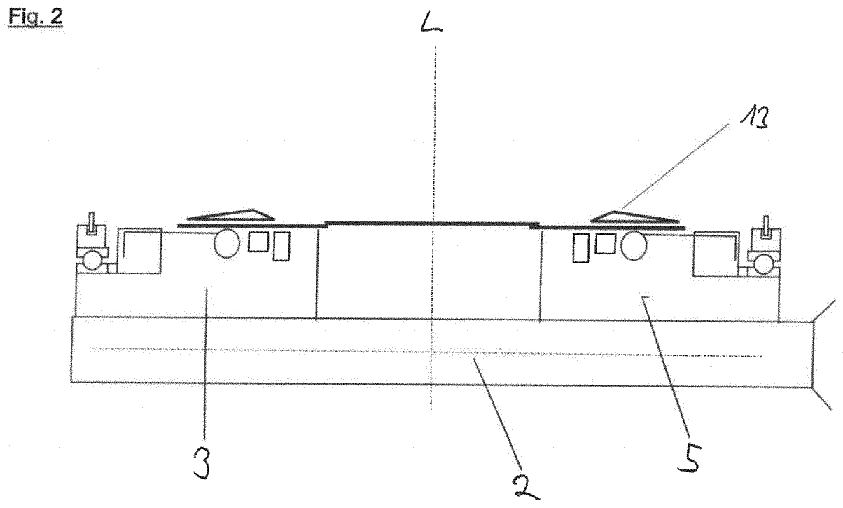

FIG. 2 a longitudinal section through the tire building drum shown in FIG. 1, with sidewall material applied thereto;

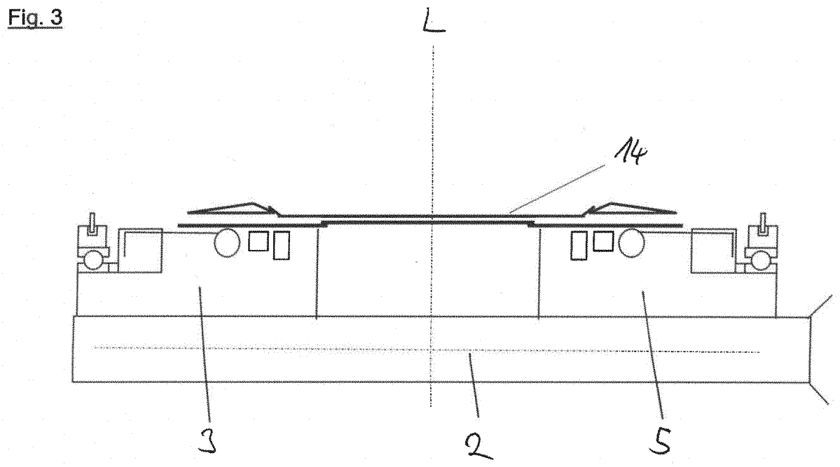

FIG. 3 a longitudinal section through the tire building drum shown in FIG. 2 with inner liner material additionally applied thereto;

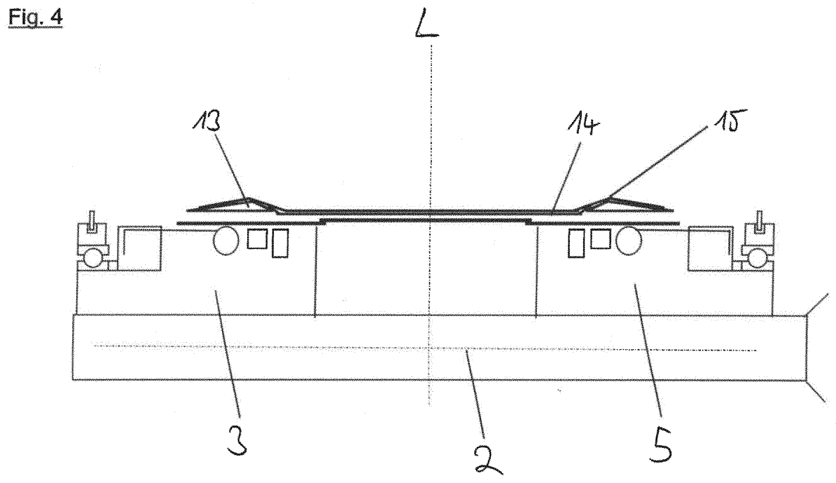

FIG. 4 a longitudinal section through the tire building drum shown in FIG. 3, with body ply material additionally applied thereto;

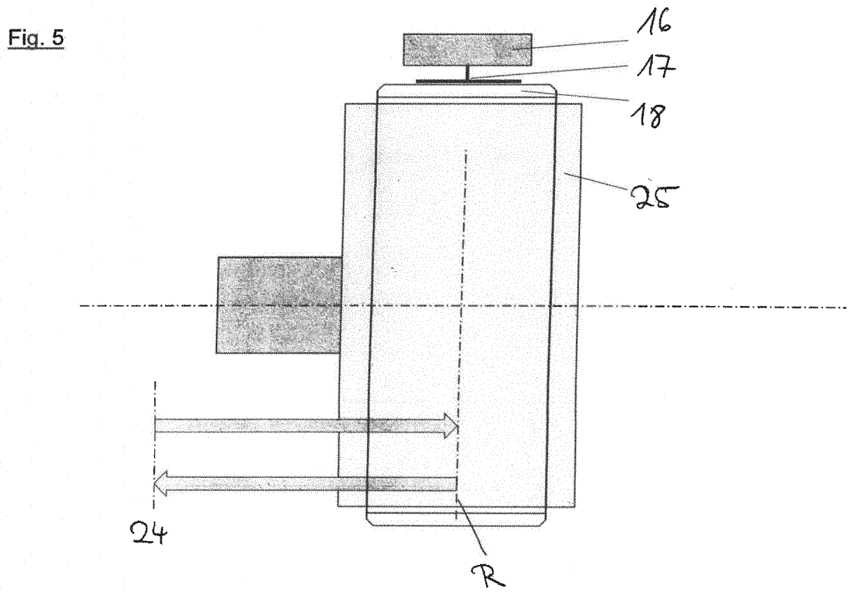

FIG. 5 an illustration of the transfer of the belt drum from the running strip server to the tire building ring in an apparatus according to the invention for manufacturing tires;

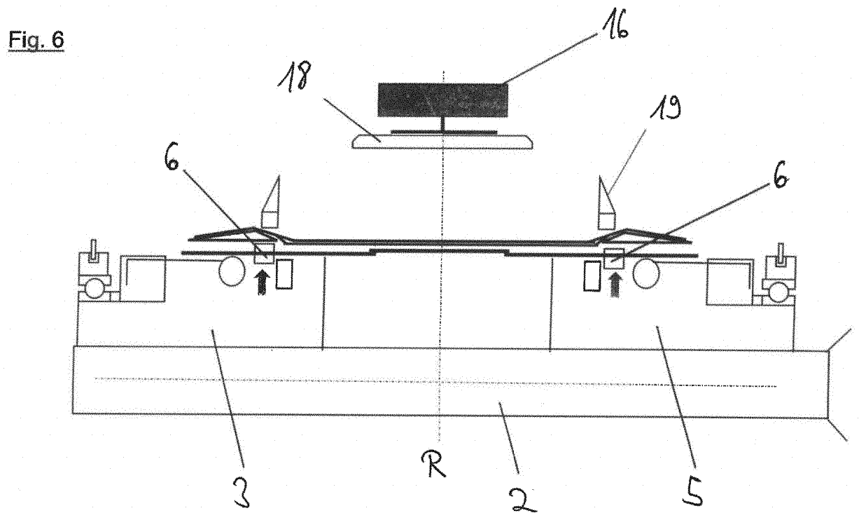

FIG. 6 a longitudinal section through the tire building drum shown in FIG. 4, positioned in the tire building ring with set cores;

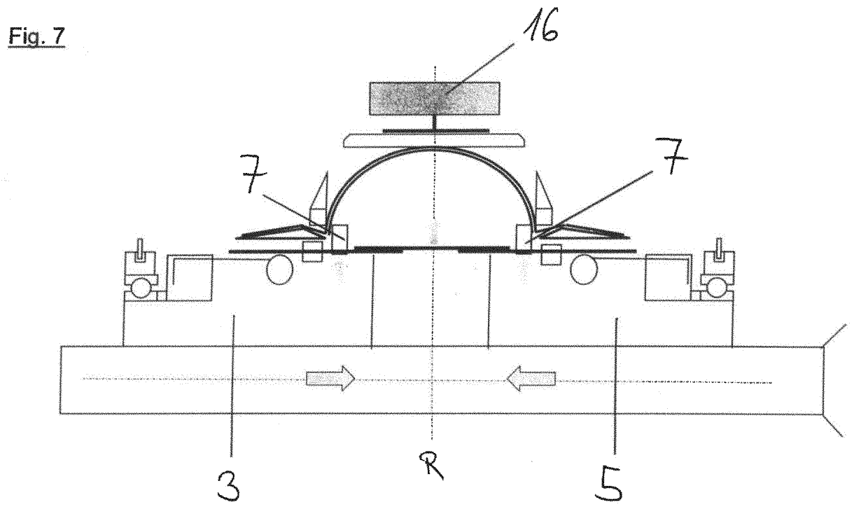

FIG. 7 a longitudinal section through the tire building drum shown in FIG. 6, with an extended inner shoulder and aerated casing;

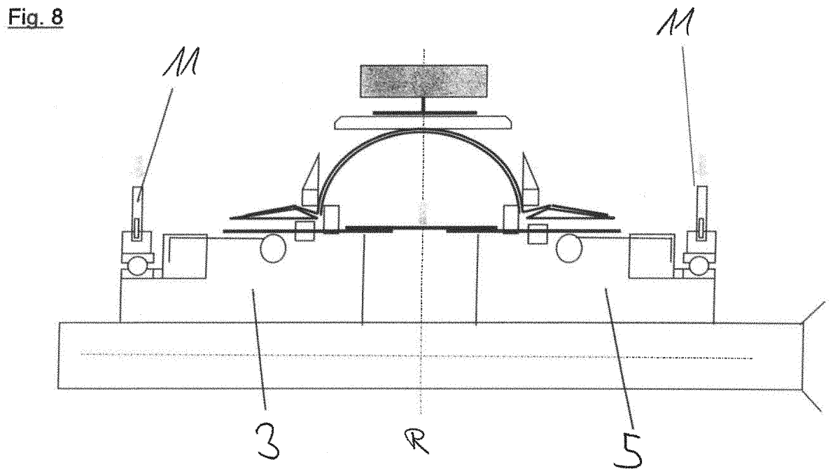

FIG. 8 a longitudinal section through the tire building drum shown in FIG. 7, with drivers positioned in the ring grooves of the slide rings;

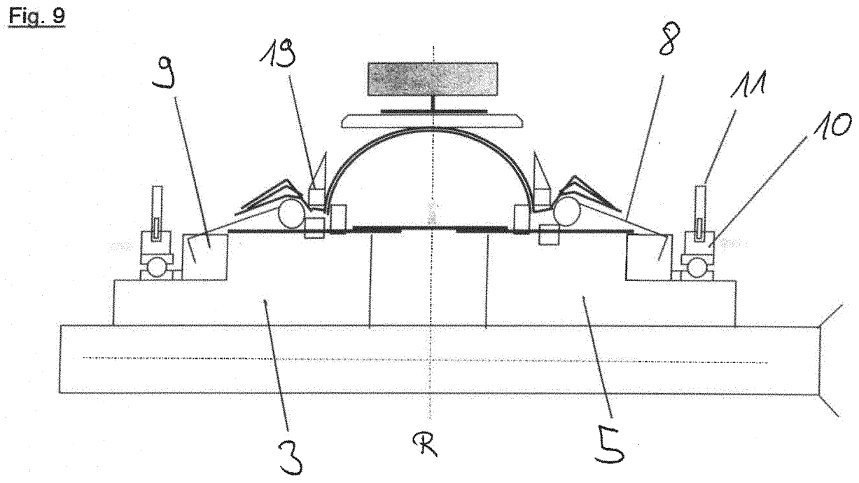

FIG. 9 a longitudinal section through the tire building drum shown in FIG. 8, with turn-up fingers which are displaced for ply turn-up and for realizing an outer shoulder;

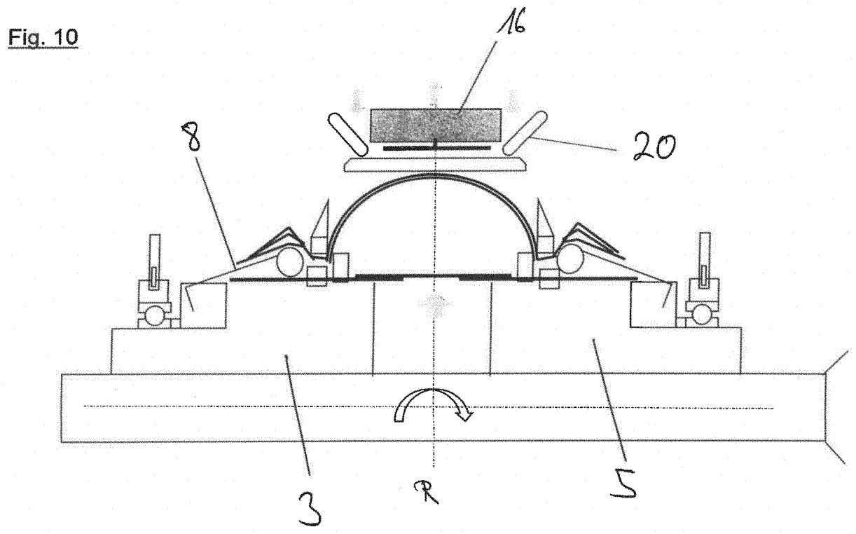

FIG. 10 a longitudinal section through the tire building drum shown in FIG. 9 before the turn-up process and with an illustration of the rolling apparatus for the belt package;

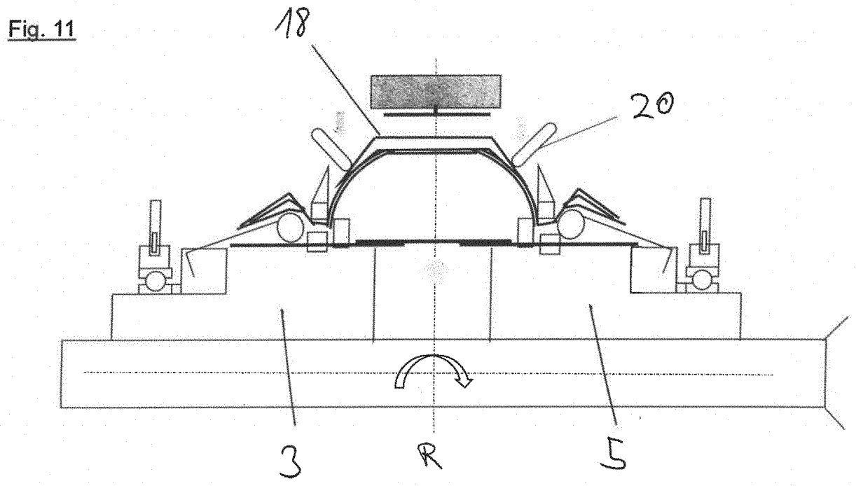

FIG. 11 a longitudinal section through the tire building drum shown in FIG. 10 with the belt package of the running strip additionally connected to the casing after rolling;

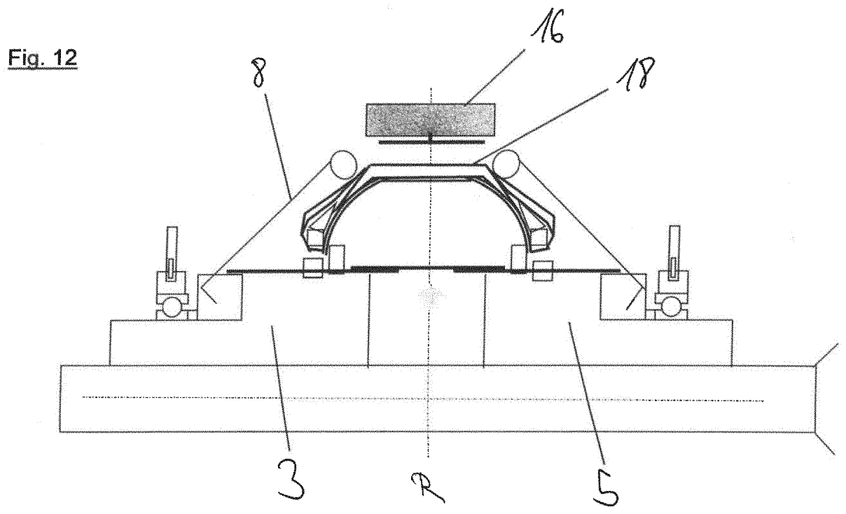

FIG. 12 a longitudinal section through the tire building drum shown in FIG. 11 after the ply turn-up for an SOT construction of the green tire has taken place;

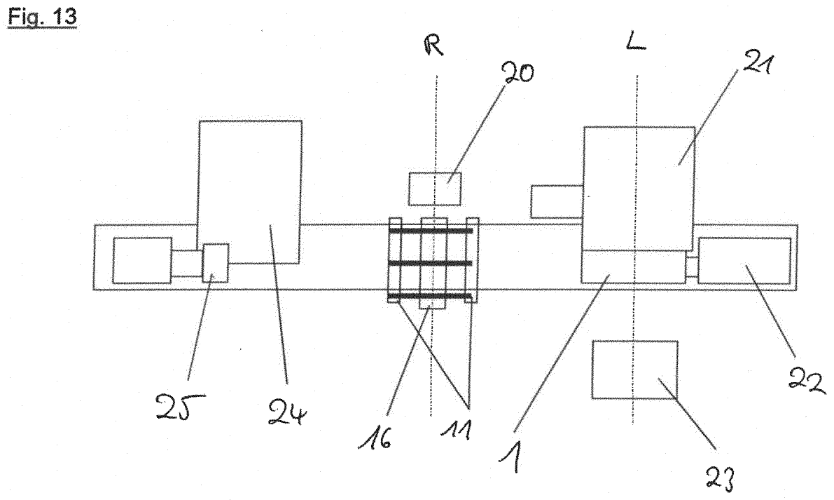

FIG. 13 a schematic illustration of an apparatus according to the invention for manufacturing tires; and

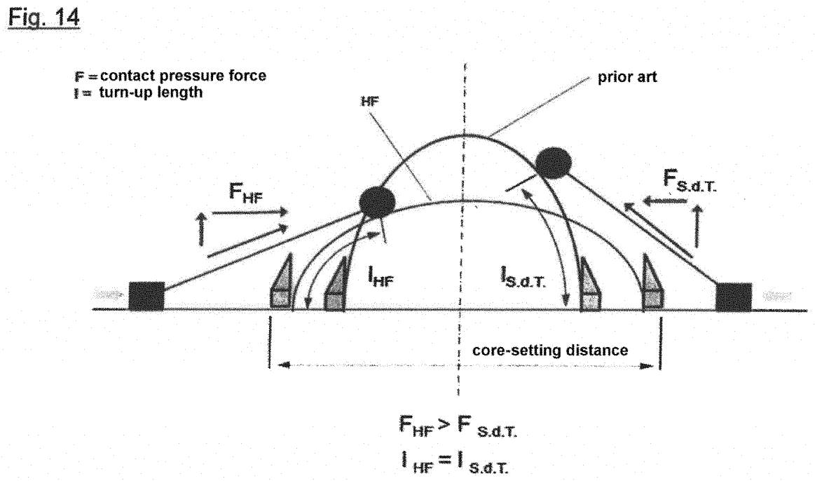

FIG. 14 a schematic illustration of the core-setting distances and the resultant contact pressure forces.

The detail of a tire building drum (1) illustrated in FIG. 1 is arranged in the region of the center (L) of the ply server (21) and has an outboard drum half (3) and an inboard drum half (5) which are mounted on a drum shaft (2). In conjunction with a center part (4), the two drum halves (3, 5) form a cylindrical round body (drum body). The individual casing plies are processed on this round body and formed into a green tire.

Both drum halves (3, 5) can be locked on the drum shaft (2). An axial adjustment of the drum halves (3, 5) is realized by a drive which rotates a spindle, for example, and thereby generates an axial movement.

The drum halves (3, 5) each have a core clamping apparatus (6) and a shoulder support (7), which can be displaced in the radial direction relative to the drum shaft (2) of the tire building drum (1).

The drum halves (3, 5) furthermore each have a plurality of turn-up fingers (8) for realizing a ply turn-up. The turn-up fingers (8) are guided via a forced-guidance means (9) for an improved exertion of force on a green tire to be manufactured. The turn-up fingers (8) are located in longitudinal grooves within the tire building drum (1). To couple the turn-up fingers (8) to a drive (not illustrated) arranged outside the tire building drum (1), the drum halves (3, 5) each have a slide ring (10) to which the turn-up fingers (8) associated with the respective drum halves (3, 5) are connected in a rotatable manner.

A respective driver (11) coupled to the drive for the turn-up fingers (8), which is arranged outside the tire building drum (1), is displaced into the ring groove (10a) of the slide rings (10) so that a coupling of the turn-up fingers (8) to the drive is realized.

The slide rings (10) are each connected to the drum halves (3, 5) via a rotatable bearing (12), which is realized as a respective anti-friction bearing in the illustrated embodiment of the invention.

An inventive tire building drum (1) corresponding to FIG. 1 is shown in FIG. 2. A process step of the method according to the invention for manufacturing tires is furthermore illustrated. While the tire building drum (1) is located in the region of the center of the ply server (21) of the apparatus according to the invention for manufacturing tires, the different material plies are applied in succession. FIG. 2 shows the tire building drum (1) after the sidewall material (13) has been applied. The inner liner material (14) is then applied, which is shown in FIG. 3. In FIG. 4, the tire building drum (1) is shown after the application of the body ply material (15), which is applied to the previously applied plies (13, 14).

FIG. 5 shows the next step of the method according to the invention for manufacturing tires. The belt drum (25) is transferred from the running strip server (24) to the tire building ring (16). The tire building ring (16) has a gripper (17), which receives the belt package (18) of the green tire from the belt drum (25) and holds said belt package. To this end, the belt drum (25) is positioned in the region of the center line (R) of the tire building ring (16). After the belt package (18) has been received by the gripper (17) of the tire building ring (16), the belt drum (25) is transferred back to the running strip server (24).

FIG. 6 shows the longitudinal section of a tire building drum (1) according to the invention, which has been transferred to the tire building ring (16) after the process step shown in FIG. 5. The cores (19) have been set and are fixed in position with the aid of the radially outwardly displaced core clamping apparatus (6).

The following step, illustrated in FIG. 7, of the method according to the invention for manufacturing tires is the displacement of the drum halves (3, 5) so that the core distance is realized in the shaping position. Furthermore, in the method step illustrated, the shoulder support (7) is extended and the casing is aerated under low pressure. The required internal pressure is realized pneumatically, for example.

FIG. 8 shows the subsequent step of the method according to the invention for manufacturing tires. The drivers (11) coupled to the drive arranged outside the tire building drum (1) are displaced into the ring grooves (10a) of the slide rings (10) with the aid of the drive, whereby a coupling of the turn-up fingers (8) to the drive is realized.

As shown in FIG. 9, the drivers (11) are then displaced in the axial direction towards the center part (4) of the tire building drum (1), whereby the turn-up fingers (8) are activated according to the movement specified by the forced-guidance means (9). When the drivers (11) are moved together, the turn-up fingers (8) rise against the cores (19) and form outer shoulders for a green tire to be manufactured.

In this case, the turn-up fingers (8), which are advantageously evenly distributed in the circumferential direction, firstly run up a ring-shaped mechanical surface (not illustrated) via rollers on their side facing the green tire, which mechanical surface is arranged at an angle.

Then, as illustrated in FIG. 10, the gripper (17) holding the belt package (18) is released. The tire building drum (1) is rotated about the drum shaft (2) and the internal pressure of the casing is increased. The outer shoulder realized by the turn-up fingers (8) fixes the casing, together with the shoulder support (7), on the tire building drum (1). As a result of the inventive rotatable bearing (12) of the slide rings (10), the drive arranged outside the tire building drum (1) and the turn-up fingers (8) remain coupled while the tire building drum (1) rotates. The belt package (18) is rolled along the casing with the aid of a rolling apparatus (20).

The method step of rolling the belt package (18) along the casing is illustrated further in FIG. 11. The rolling apparatus (20) has rolled the sides of the belt package (18) onto the casing. In this case, the tire building drum (1) rotates about its drum shaft (2), wherein the casing is further fixed in the region of the cores (19) by the turn-up fingers (8) and the shoulder support (7).

FIG. 12 illustrates the method step of rolling the sidewalls of the belt package (18) of the running strip onto the casing. The turn-up fingers (8) are moved upwards by moving the drivers (11) further together, whereupon the elastomer material of the previously placed plies is then raised and turned up around the core (19). In a further step, the rollers on the turn-up fingers (8) press the material against the casing.

Upon the subsequent withdrawal of the slide rings (10) by moving the drivers (11) apart, the turn-up fingers (8) are lowered back into the longitudinal grooves of the tire building drum (1). The drivers (11) are then moved back and release the ring grooves (10a) of the slide rings (10) again.

By retracting the core clamping apparatus (6) and shoulder support (7), the green tire is then released from the tire building drum (1).

An advantageous embodiment of an apparatus according to the invention for manufacturing tires is illustrated schematically in FIG. 13. The apparatus for manufacturing tires has a tire building drum (1), which is arranged in the region of the center (L) of the ply server (21) in the illustrated method step. A casing machine (22) is furthermore arranged near to the tire building drum (1) in the region of the ply server (21).

The illustrated embodiment of an apparatus for manufacturing tires furthermore has an insert server (23), by means of which reinforcing strips can be incorporated in a green tire to be manufactured.

The apparatus for manufacturing tires moreover has a tire building ring (16), in the region of which the drivers (11) and the roller (20) are arranged.

The apparatus additionally has a running strip server (24), by means of which the belt package (18) of a green tire to be manufactured can be produced on a belt drum (25).

FIG. 14 shows a depiction of the contact pressure force F occurring as a result of the inventive core setting in the turn-up process. The green tire has a contour which, compared to the prior art, is flatter or, at most, equal in height owing to the larger or at least equal distance of the set cores with respect to one another. With the same turn-up length I, the relevant horizontal force component F_{HF} of the force vector in the inventive embodiment of an apparatus for manufacturing tires is greater than or at least equal to the horizontal force component F_{SdT} according to the prior art.

1-16. (canceled)

17. An apparatus for manufacturing tires, comprising: a tire building drum for manufacturing uncured green tires; a drive arranged outside the tire building drum, the tire building drum having a device for creating a ply turn-up, wherein the device for creating the ply turn-up includes a plurality of turn-up fingers that are couplable to the drive arranged outside the tire building drum; and two slide rings that couple the turn-up fingers to the drive, wherein the turn-up fingers are couplable to the drive and controlled thereby both in a stationary state of the tire building drum and during a rotation of the tire building drum.

18. The apparatus according to claim 17, wherein the slide rings each have a rotatable bearing that provides the coupling of the turn-up fingers to the drive arranged outside the tire building drum.

19. The apparatus according to claim 18, wherein the respective rotatable bearing of the slide rings is an anti-friction bearing by which radial and axial forces are absorbed.

20. The apparatus according to claim 17, wherein the tire building drum includes a drum shaft, an outboard drum half, an inboard drum half and a center part, wherein at least the drum halves are displaceable axially on the drum shaft.

21. The apparatus according to claim 17, wherein the drive for the turn-up fingers which is arranged outside the tire building drum is a servo drive.

22. The apparatus according to claim 17, wherein the slide rings each have a ring groove that couples the turn-up fingers to the drive arranged outside the tire building drum.

23. The apparatus according to claim 20, wherein the drive arranged outside the tire building drum includes a plurality of separately driven spindles that are mounted in a stationary tire building ring and run synchronously in opposite directions.

24. The apparatus for manufacturing tires, according to claim 17, further comprising a casing machine configured so that, by using different tire building drums, both green tires with a flat construction and green tires with a crown construction are producible.

25. The apparatus for manufacturing tires according to claim 24, further comprising a second drive unit arranged in the casing machine so as to enable a flexible production of green tires with a flat or crown construction.

26. The apparatus for manufacturing tires according to claim 23, further comprising radially displaceable drives that couple the drive in the stationary tire building ring to the slide rings.

27. The apparatus for manufacturing tires according to claim 17, further comprising a force guide that guides the turn-up fingers in terms of movement.

28. The apparatus for manufacturing tires according to claim 17, further comprising a core clamping apparatus, wherein the turn-up fingers are controlled so that at least one outer shoulder is at least temporarily realized thereby, via which, in addition to the core clamping apparatus, cores can also be fixed externally during a rotation of the tire building drum.

29. The apparatus for manufacturing tires according to claim 28, wherein a more efficiently usable material contact pressure force is achieved in that a core-setting distance is specified during a turn-up process so that the core-setting distance achieved is greater than or equal to a smallest core to core measurement reached in a further tire building process.

30. A method for manufacturing tires, comprising the steps of: driving a turn-up process of green tire material by a drive for turn-up fingers, the drive being mounted outside a tire building drum; and carrying out a turn-up of plies of the material of the green tire during rotation of the tire building drum.

31. The method according to claim 30, including synchronously controlling a turn-up mechanism on both drum halves of the tire building drum to provide an even turn-up of the plies of the green tire.

32. The method according to claim 30, including producing an advantageous force/angle ratio by a core setting with a core to core distance of greater than or equal to a smallest core distance reached in a further course of green tire manufacture to enable effective use of a material contact pressure force.
